(19) United States
(12) Patent Application Publication
(10) Pub. No.: US 2006/0007064 A1
(43) Pub. Date: Jan. 12, 2006

(54) Plasma display apparatus and driving method thereof

(75) Inventors: Jeong Pil Choi, Suwon-si (KR); Sung Chun Choi, Anyang-si (KR); Byung Goo Kong, Seoul (KR); Seong Hak Moon, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/159,320

(22) Filed: Jun. 23, 2005

(30) Foreign Application Priority Data
Jun. 25, 2004 (KR) 10-2004-0048438

(51) Int. Cl. G09G 3/28

(52) U.S. Cl. 345/60

(57) ABSTRACT

A plasma display apparatus, more particularly to a plasma display apparatus for applying a negative sustain waveform while being driven and a method of driving the same are provided. The plasma display apparatus includes a plasma display panel in which a plurality of electrodes including scan electrodes and sustain electrodes are formed, driving parts for driving the plurality of electrodes, and a driving pulse controlling part for controlling the driving parts so that a scan reference waveform of a voltage level no more than a ground voltage level and a negative scan waveform of a voltage level lower than the voltage level of the scan reference waveform and higher than the voltage level of the negative sustain waveform are applied to the scan electrodes in an address period and that a negative sustain waveform is alternately applied to the scan electrodes and the sustain electrodes in a sustain period.

This nonprovisional application claims priority under 35 U.S.C. § 119(a) on Patent Application No. 10-2004-0048438 filed in Republic of Korea on Jun. 25, 2004, the entire contents of which are hereby incorporated by reference.

### BACKGROUND OF THE INVENTION

1. Field of the Invention

The present invention relates to a plasma display apparatus, and more particularly to a plasma display apparatus for applying a negative sustain waveform while being driven and a method of driving the same.

2. Description of the Background Art

In general, a plasma display apparatus includes a plasma display panel (PDP) in which a barrier rib formed between a top surface substrate and a bottom surface substrate forms a unit cell. A main discharge gas such as Ne, He, and Ne+He and an inactive gas including a small amount of xenon are filled in each cell. When discharge is generated by a high frequency voltage, the inactive gas generates vacuum ultraviolet (UV) rays and emits light from a phosphor formed between the barrier ribs to realize an image. Since the plasma display apparatus can be made thin and light, the plasma display apparatus is spotlighted as a next generation display apparatus.

FIG. 1 illustrates the structure of a common PDP.

As illustrated in FIG. 1, according to the PDP, a top surface substrate 100 obtained by arranging a plurality of pairs of electrodes formed of scan electrodes 102 and sustain electrodes 103 that make pairs on a top surface glass 101 that is a display surface on which images are displayed and a bottom surface substrate 110 obtained by arranging a plurality of address electrodes 113 on a bottom surface glass 111 that forms the back surface so as to intersect the plurality of pairs of sustain electrodes are combined with each other to run parallel to each other by a uniform distance.

The top surface substrate 100 is covered with one or more dielectric layers 104 for restricting the discharge current of the scan electrodes 102 and the sustain electrodes 103 for discharging each other in one discharge cell to sustain electroluminescence of the cell, that is, the scan electrodes 102 and the sustain electrodes 103 including transparent electrodes a formed of transparent indium tin oxide (ITO) and bus electrodes b formed of metal to insulate the pairs of electrodes from each other. A protective layer 105 on which MgO is deposited is formed on the entire surface of the dielectric layer 104 in order to facilitate discharge.

Stripe type (or well type) barrier ribs 112 for forming a plurality of discharge spaces, that is, discharge cells are arranged on the bottom surface substrate 110 to run parallel to each other. Also, the plurality of address electrodes 113 that perform address discharge are arranged to run parallel with respect to the barrier ribs 112. The bottom surface substrate 110 is coated with the R, G, and B phosphors 114 that emit visible rays to display images during sustain discharge. A dielectric layer 115 for protecting the address electrodes 113 is formed between the address electrodes 113 and the phosphors 114.

FIG. 2 illustrates a method of realizing images of a conventional plasma display apparatus.

As illustrated in FIG. 2, the plasma display apparatus divides one frame period into a plurality of sub-fields having different number of times of discharge and emits light from the PDP in a sub-field period corresponding to the gray scale value of an input image signal so that an image is realized.

Each sub-field is divided into a reset period for uniformly generating discharge, an address period for selecting discharge cells, and a sustain period for realizing gray scales in accordance with the number of times of discharge. For example, when an image is to be displayed by 256 gray scales, a frame period (16.67 ms) corresponding to 1/60 second is divided into eight sub-fields.

Each of the eight sub-fields is divided into the reset period, the address period, and the sustain period. Here, the sustain period in each sub-field increases in the ratio of 2n (n=0. 1. 2. 3. 4. 5. 6, and 7). As described above, since the sustain period varies with each sub-field, it is possible to realize gray scales of an image. The driving principle of the plasma display apparatus will be described with reference to FIGS. 3A and 3B.

FIG. 3A illustrates driving waveforms of the conventional plasma display apparatus.

As illustrated in FIG. 3A, the conventional plasma display apparatus is driven such that each sub-field is divided into a reset period for initializing all of the cells, an address period for selecting a cell to be discharged, a sustain period for sustaining the discharge of the selected cell, and an erase period for erasing wall charges in the discharged cell.

In the set up period of the reset period, a rising ramp waveform Ramp-up is simultaneously applied to all of the scan electrodes. Dark discharge is generated in the discharge cells of the entire screen due to the rising ramp waveform. Positive wall charges are accumulated on the address electrodes and the sustain electrodes and negative wall charges are accumulated on the scan electrodes due to the set up discharge.

In the set down period of the reset period, after the rising ramp waveform is supplied, a falling ramp waveform Ramp-down that starts to fall from a positive voltage lower than the peak voltage of the rising ramp waveform and to thus fall to a specific voltage level no more than a ground GND level generates weak erase discharge in the cells to erase the wall charges excessively formed in the scan electrodes.

In the address period, a negative scan pulse is sequentially applied to the scan electrodes and, at the same time, a positive address pulse is applied to the address electrodes in synchronization with the scan pulse. When difference in voltage between the scan pulse and the address pulse is added to the wall voltage generated in the reset period, address discharge is generated in the discharge cell to which the address pulse is applied. Wall charges to the amount that can generate discharge when the sustain voltage Vs is applied are formed in the cells selected by the address discharge. A positive bias voltage Vzb is supplied to the sustain electrodes.

In the sustain period, sustain pulses sus are alternately applied to the scan electrodes and the sustain electrodes. In the cells selected by the address discharge, the wall voltage in the cells is added to the sustain pulse such that the sustain discharge, that is, display discharge is generated between the scan electrodes and the sustain electrodes whenever each sustain pulse is applied.

After the sustain discharge is completed, a voltage of an erase ramp waveform Ramp-ers having small pulse width and voltage level is supplied to the sustain electrodes in the erase period to erase the wall charges that reside in the cells of the entire screen.

The wall charges distributed in the discharge cells due to such a driving pulse will be described with reference to FIG. 3B.

FIG. 3B illustrates the wall charges distributed in the discharge cells in accordance with the conventional driving waveforms.

Referring to FIG. 3B, in the set up period of the reset period, the pulse of the positive rising ramp is supplied to the scan electrodes Y and a pulse having the potential lower than the pulse supplied to the scan electrodes Y is supplied to the sustain electrodes Z and the address electrodes X such that negative charges are positioned on the scan electrodes Y and that the positive charges are positioned on the sustain electrodes Z and the address electrodes X as illustrated in (a) of FIG. 3B.

Then, in the set down period, the pulse of the falling ramp is supplied to the scan electrodes Y and a predetermined bias voltage, preferably, a voltage of a ground level GND is supplied to and sustained in the sustain electrodes Z and the address electrodes X such that the wall charges excessively accumulated on the discharge cells are partially erased in the set up period as illustrated in (b) of FIG. 3B. The wall charges are uniformly distributed in the discharge cells through such an erasing process.

Then, in the address period, address discharge is generated by the scan pulse supplied to the scan electrodes Y and the address pulse supplied to the address electrodes X as illustrated in (c) of FIG. 3B.

Then, in the sustain period, the sustain pulse is alternately applied to the scan electrodes Y and the sustain electrodes Z so that sustain discharge is generated as illustrated in (d) of FIG. 3B.

As described above, according to the conventional art, when the plasma display apparatus is driven, a high voltage Vs sustain pulse is used in order to start and sustain discharge. There is high probability of generating driving error and mis-discharge when the plasma display apparatus is driven in a high voltage. Therefore, according to the conventional art, a high voltage switching device is necessary and the high voltage switching device serves as a main factor of increase in the price of the plasma display apparatus.

Therefore, various methods of reducing the driving voltage of the plasma display apparatus so that the plasma display apparatus is normally driven with low power consumption are illustrated in FIG. 4.

FIG. 4 illustrates negative sustain waveforms of the conventional plasma display apparatus.

As illustrated in FIG. 4, the conventional plasma display apparatus is driven by a negative sustain driving method as a driving method with lower power consumption. According to the negative sustain driving method, a negative sustain voltage Vs is applied to the scan electrodes or the sustain electrodes of the top surface substrate and the ground voltage GND is applied to the address electrodes of the bottom surface substrate. At this time, before the surface discharge of the scan electrodes and the sustain electrodes, opposite discharge is generated between the scan electrodes or the sustain electrodes and the address electrodes. The charges generated by the opposite discharge become seeds that cause the surface discharge.

That is, the positive charges move toward the top surface substrate through the opposite discharge to collide with the MgO protective layer. Therefore, secondary electrons are emitted. The secondary electrons serve as the seeds of the surface discharge so that the surface discharge is smoothly generated. Therefore, according to the conventional negative sustain driving method, sustain driving is performed by a lower voltage than the conventional positive sustain driving method due to the priming effect caused by the opposite discharge.

However, according to the conventional negative sustain driving method, the negative low voltage is used only in the sustain period. That is, the positive high voltage is used in the remaining periods such as the reset period, the address period, and the erase period like in the positive sustain driving method. Therefore, according to the conventional negative sustain driving method, the high voltage switching device is used so that reactive power increases due to the high voltage.

### SUMMARY OF THE INVENTION

Accordingly, an object of the present invention is to solve at least the problems and disadvantages of the background art.

It is an object of the present invention to provide a plasma display apparatus capable of reducing driving voltage and of improving driving efficiency and a method of driving the same.

It is another object of the present invention to provide a plasma display apparatus capable of being stably driven and a method of driving the same.

It is still another object of the present invention to provide a plasma display apparatus capable of reducing the number of high voltage switching devices to reduce manufacturing cost.

A plasma display apparatus according to a first embodiment of the present invention includes a plasma display panel in which a plurality of electrodes including scan electrodes and sustain electrodes are formed, driving parts for driving the plurality of electrodes, and a driving pulse controlling part for controlling the driving parts so that a scan reference waveform of a voltage level no more than a ground voltage level and a negative scan waveform of a voltage level lower than the voltage level of the scan reference waveform and higher than the voltage level of the negative sustain waveform are applied to the scan electrodes in an address period and that a negative sustain waveform is alternately applied to the scan electrodes and the sustain electrodes in a sustain period.

According to the first embodiment of the present invention, there is provided a method of driving a plasma display apparatus in which a negative sustain waveform is alternately applied to the scan electrodes and the sustain electrodes in a sustain period. In the method, a scan reference waveform of the voltage level no more than a ground voltage level and a negative scan waveform of the voltage level lower than the voltage level of the scan reference waveform and higher than the voltage level of the negative sustain waveform are applied to the scan electrodes in an address period.

A plasma display apparatus according to a second embodiment of the present invention comprises a plasma display panel in which a plurality of electrodes including the scan electrodes and the sustain electrodes are formed, driving parts for driving the plurality of electrodes, and a driving pulse controlling part for controlling the driving part so that a positive set-up waveform is applied to the scan electrodes and that a negative waveform is applied to the sustain electrodes in a set-up period and that a negative sustain waveform is alternately applied to the scan electrodes and the sustain electrodes in a sustain period.

According to the second embodiment of the present invention, there is a method of driving a plasma display apparatus in which a negative sustain waveform is alternately applied to scan electrodes and sustain electrodes. In the method, a positive set-up waveform is applied to the scan electrodes and a negative waveform is applied to the sustain electrodes in a set-up period.

According to the present invention, the plasma display apparatus and the method of driving the same are improved to reduce the driving voltage and to improve the driving efficiency of the plasma display apparatus.

Also, according to the present invention, the plasma display apparatus and the method of driving the same are improved to stably drive the plasma display apparatus.

Also, according to the present invention, the specifications of the parts are reduced to reduce manufacturing cost.

### BRIEF DESCRIPTION OF THE DRAWINGS

The present invention will be described in detail with reference to the following drawings in which like numerals refer to like elements.

FIG. 1 illustrates the structure of a common plasma display panel (PDP).

FIG. 2 illustrates a method of realizing an image of the conventional plasma display apparatus.

FIG. 3A illustrates driving waveforms of the conventional plasma display apparatus.

FIG. 3B illustrates wall charges distributed on the discharge cells in accordance with the conventional driving waveforms.

FIG. 4 illustrates negative sustain waveforms of the conventional plasma display apparatus.

FIG. 5 illustrates the structure of a plasma display apparatus according to a first embodiment of the present invention.

FIG. 6 illustrates waveforms of the plasma display apparatus according to the first embodiment of the present invention.

FIG. 7 illustrates a modification of the driving waveforms according to the first embodiment of the present invention.

FIG. 8 illustrates the structure of a plasma display apparatus according to a second embodiment of the present invention.

FIG. 9 illustrates driving waveforms of the plasma display apparatus according to the second embodiment of the present invention.

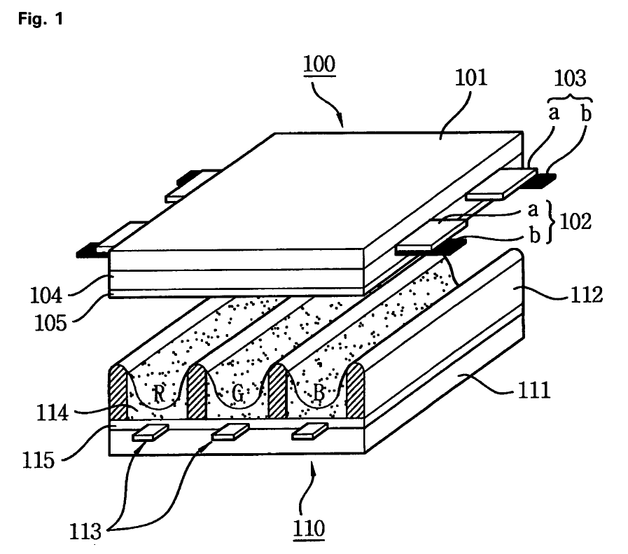

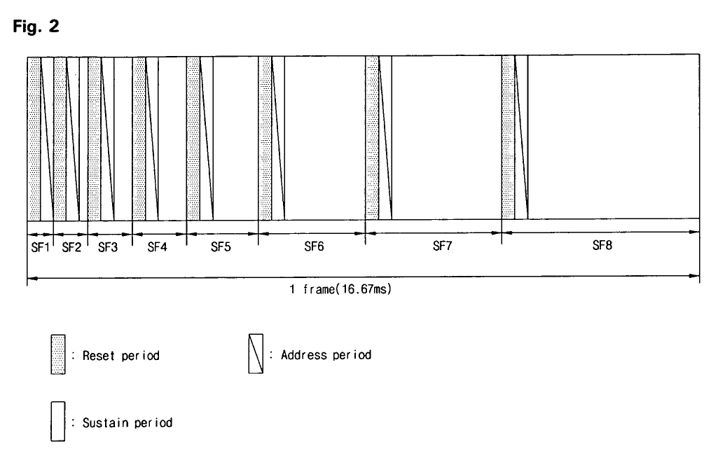

### DETAILED DESCRIPTION OF PREFERRED EMBODIMENTS

Preferred embodiments of the present invention will be described in a more detailed manner with reference to the drawings.

A plasma display apparatus according to a first embodiment of the present invention includes a plasma display panel in which a plurality of electrodes including scan electrodes and sustain electrodes are formed, driving parts for driving the plurality of electrodes, and a driving pulse controlling part for controlling the driving parts so that a scan reference waveform of a voltage level no more than a ground voltage level and a negative scan waveform of a voltage level lower than the voltage level of the scan reference waveform and higher than the voltage level of the negative sustain waveform are applied to the scan electrodes in an address period and that a negative sustain waveform is alternately applied to the scan electrodes and the sustain electrodes in a sustain period.

According to the present invention, a reference waveform of the ground voltage level is applied to the sustain electrodes in the address period.

According to the present invention, after address discharge of the address period is completed, the sustain electrodes are sustained in the ground voltage level and a negative waveform is applied to the scan electrodes for a predetermined time.

According to the present invention, the predetermined time is no less than 1 us.

According to the present invention, the voltage level of the negative waveform is the same as the voltage level of the negative sustain waveform.

A plasma display apparatus according to a second embodiment of the present invention comprises a plasma display panel in which a plurality of electrodes including the scan electrodes and the sustain electrodes are formed, driving parts for driving the plurality of electrodes, and a driving pulse controlling part for controlling the driving part so that a positive set-up waveform is applied to the scan electrodes and that a negative waveform is applied to the sustain electrodes in a set-up period and that a negative sustain waveform is alternately applied to the scan electrodes and the sustain electrodes in a sustain period.

According to the present invention, the positive set-up waveform is a rising ramp waveform that gradually rises in a ground GND voltage level.

According to the present invention, the magnitude of the voltages of the positive set-up waveform and the negative waveform is equal to the magnitude of the voltage of the negative sustain waveform

According to the present invention, the voltage level of the negative sustain waveform is −160V to −200V.

According to the present invention, a negative set-down waveform having the voltage level the same as the voltage level of a scan waveform is applied to the scan electrodes in a set-down period.

According to the present invention, after the final negative sustain waveform of the sustain period is applied to one of the scan electrodes and the sustain electrodes, a negative erase waveform is applied to the opposite electrodes of the electrodes to which the final negative sustain waveform is applied.

According to the present invention, the negative erase waveform is a rising ramp waveform that gradually rises from the voltage level of the negative sustain waveform to the ground voltage level.

According to the present invention, the time for which the negative erase waveform is applied is no less than 2 us.

According to the present invention, a negative waveform is applied to the electrodes to which the final sustain waveform is applied while a negative erase waveform is applied to the opposite electrodes.

According to the first embodiment of the present invention, there is provided a method of driving a plasma display apparatus in which a negative sustain waveform is alternately applied to the scan electrodes and the sustain electrodes in a sustain period. In the method, a scan reference waveform of the voltage level no more than a ground voltage level and a negative scan waveform of the voltage level lower than the voltage level of the scan reference waveform and higher than the voltage level of the negative sustain waveform are applied to the scan electrodes in an address period.

According to the present invention, a reference waveform of a ground voltage level is applied to the sustain electrodes in the address period.

According to the present invention, after address discharge of the address period is completed, a ground voltage level is sustained in the sustain electrodes and a negative waveform is applied to the scan electrodes for a predetermined time.

According to the present invention, the predetermined time is no less than 1 us.

According to the present invention, the voltage level of the negative waveform is the same as the voltage level of a negative sustain waveform.

According to the second embodiment of the present invention, there is provided a method of driving a plasma display apparatus in which a negative sustain waveform is alternately applied to scan electrodes and sustain electrodes. In the method, a positive set-up waveform is applied to the scan electrodes and a negative waveform is applied to the sustain electrodes in a set-up period.

According to the present invention, the positive set-up waveform is a rising ramp waveform that gradually rises from a ground voltage level.

According to the present invention, the magnitude of the voltages of the positive set-up waveform and the negative waveform is equal to the magnitude of the voltage of a negative sustain waveform.

According to the present invention, the voltage level of the negative sustain waveform is −160V to −200V.

According to the present invention, a negative set-down waveform having the same voltage level as the voltage level of a scan waveform is applied to the scan electrodes in a set-down period.

According to the present invention, after the final negative sustain waveform of the sustain period is applied to one of the scan electrodes and the sustain electrodes, a negative erase waveform is applied to the opposite electrodes of the electrodes to which the negative sustain waveform is applied.

According to the present invention, the negative erase waveform is a rising ramp waveform that gradually rises from the voltage level of the negative sustain waveform to the ground voltage level.

According to the present invention, the time for which the negative erase waveform is applied is no less than 2 us.

According to the present invention, while a negative erase waveform is applied to the opposite electrodes, a negative waveform is applied to the electrodes to which the final sustain waveform is applied.

Hereinafter, specific embodiments according to the present invention will be described with reference to the attached drawings.

### First Embodiment

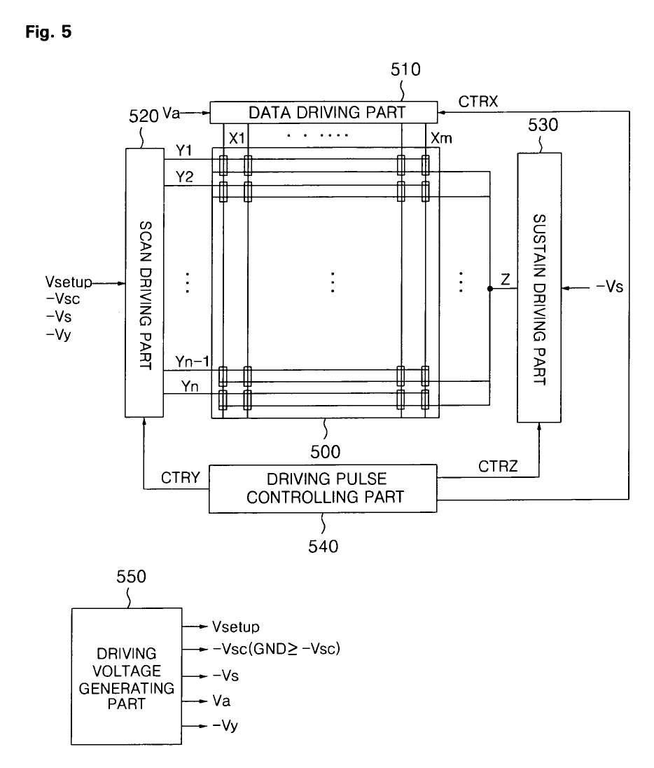

FIG. 5 illustrates the structure of a plasma display apparatus according to the first embodiment of the present invention.

As illustrated in FIG. 5, the plasma display apparatus according to the first embodiment of the present invention includes a plasma display panel (PDP) 500, a data driving part 510, a scan driving part 520, a sustain driving part 530, a driving pulse controlling part 540, and a driving voltage generating part 550.

The PDP 500 includes scan electrodes Y1 to Yn, sustain electrodes Z, and a plurality of address electrodes X1 to Xm that intersect the scan electrodes Y1 to Yn and the sustain electrodes Z.

The data driving part 510 applies data to the address electrodes X1 to Xm formed in the PDP 500. Here, the data is image signal data processed by an image signal processing part (not shown) that processes image signals input from the outside. The data driving part 510 samples data in response to the data timing control signal CTRX from the driving pulse controlling part 540 to latch the same and then, supplies an address pulse having an address voltage Va to the address electrodes X1 to Xm, respectively.

The scan driving parts 520 drive the scan electrodes Y1 to Yn formed in the plasma display panel 500. First, in the reset period, the scan driving part 520 forms a ramp waveform under the control of the driving pulse controlling part 540 and supplies a set-up pulse that rises to a set-up voltage Vsetup level and a set-down pulse that falls to a set-down voltage −Vy to the scan electrodes Y1 to Yn. Then, in the address period, the scan pulse that is applied from a scan reference voltage −Vsc to a scan voltage −Vy is sequentially supplied to the scan electrodes Y1 to Yn. Here, the same voltage supplied by the driving voltage generating part 550, that is, −Vy is used for a set-down waveform and a scan waveform.

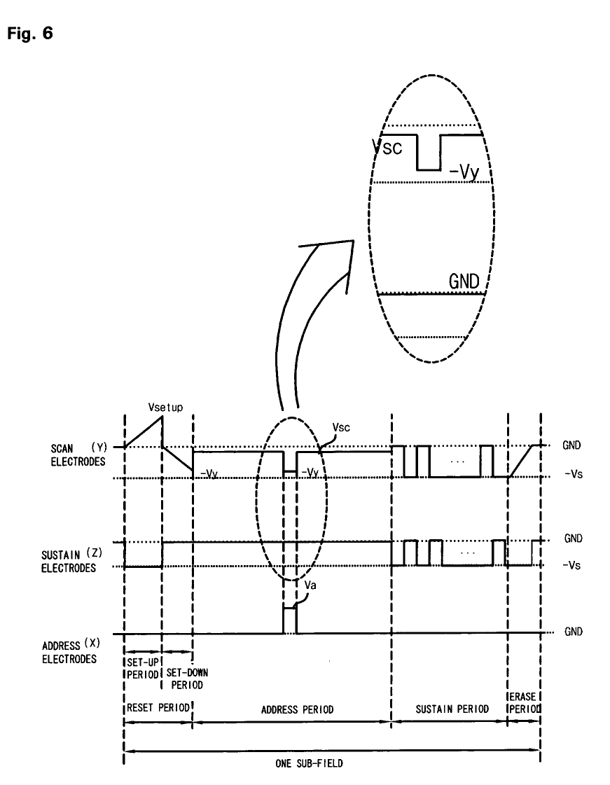

Here, the scan reference waveform according to the first embodiment of the present invention forms a voltage level no more than a ground voltage GND level and the scan waveform forms a voltage level lower than the voltage level of the scan reference waveform and higher than the voltage −Vs level of a negative sustain waveform. Detailed description of the above will be performed with reference to the driving waveforms of FIG. 6. Then, in the sustain period, the scan driving part 520 supplies one or more negative sustain pulses applied to the negative sustain voltage −Vs in the ground GND level for sustain discharge to the scan electrodes Y1 to Yn.

The sustain driving part 530 drives the sustain electrodes Z that form common electrodes in the PDP 500. The sustain driving part 530 supplies the negative pulse of the level the same as the level of the negative sustain voltage Vs to the sustain electrodes Z under the control of the driving pulse controlling part 540 in the set-up period. In the address period, the reference pulse of the ground GND voltage level is supplied to the sustain electrodes Z. In the sustain period, one or more negative sustain pulses applied to the negative sustain voltage −Vs in the ground GND voltage level for sustain discharge are supplied to the sustain electrodes Z.

The driving pulse controlling part 540 controls the data driving part 510, the scan driving part 520, and the sustain driving part 530 when the PDP 500 is driven. That is, in the reset, address, and sustain periods, the driving pulse controlling part 540 generates timing control signals CTRX, CTRY, and CTRZ for controlling the operation timing and synchronization of the data driving part 510, the scan driving part 520, and the sustain driving part 530 to transmit the timing control signals CTRX, CTRY, and CTRZ to the driving parts 510, 520, and 530, respectively.

At this time, the data control signal CTRX includes a sampling clock for sampling data, a latch control signal, and a switch control signal for controlling the on/off times of the energy frequency circuit and the driving switch device in the data driving part 510. The scan control signal CTRY includes a switch control signal for controlling the on/off times of the energy frequency circuit and the driving switch device in the scan driving part 520. The sustain control signal CTRZ includes a switch control signal for controlling the on/off times of the energy frequency circuit and the driving switch device in the sustain driving part 530.

The driving voltage generating part 550 generates driving voltages required for the driving pulse controlling part 540 and the respective driving parts 510, 520, and 530 to supply the same. That is, the driving voltage generating part 550 generates the set-up voltage Vsetup, the scan reference voltage −Vsc, the scan voltage −Vy, the sustain voltage −Vs, and the address voltage Va. The driving voltages may be controlled in accordance with the composition of discharge gas or the structure of a discharge cell.

As described above, the plasma display apparatus according to the first embodiment of the present invention applies a low driving voltage generated by the driving voltage generating part 550 under the control of the driving pulse controlling part 540 to the PDP 500 through the driving parts 510, 520, and 530. In particular, according to the first embodiment of the present invention, in the address period, the plasma display apparatus is driven in a low voltage. Here, the driving pulses formed by the plasma display apparatus according to the first embodiment of the present invention will be described with reference to FIG. 6.

FIG. 6 illustrates the driving waveforms of the plasma display apparatus according to the first embodiment of the present invention.

As illustrated in FIG. 6, the plasma display apparatus according to the first embodiment of the present invention is driven such that each sub-field is divided into a reset period for initializing all of the cells, an address period for selecting a cell to be discharged, a sustain period for sustaining the discharge of the selected cell, and an erase period for erasing wall charges in the discharged cell.

In the set up period of the reset period, a rising ramp waveform Ramp-up is simultaneously applied to all of the scan electrodes. Dark discharge is generated in the discharge cells of the entire screen due to the rising ramp waveform. Positive wall charges are accumulated on the address electrodes and the sustain electrodes and negative wall charges are accumulated on the scan electrodes due to the set up discharge.

In the set down period of the reset period, the set-down pulse of a falling ramp waveform Ramp-down that gradually falls in the ground GND voltage level is applied to generate erase discharge so that wall charges formed in the cells are erased enough. The wall charges of the amount that can stably generate the address discharge uniformly reside in the cells due to set down discharge.

At this time, considering that wall charges are excessively erased when the voltage level of the set-down pulse according to the first embodiment of the present invention falls to the voltage level no more than the same voltage −Vs level as the negative sustain pulse, the voltage level of the set-down pulse is set higher than the negative sustain voltage −Vs. Therefore, according to the first embodiment of the present invention, the negative set-down waveform having the same voltage −Vy level as the voltage level of the scan waveform is applied to the scan electrodes. It is possible to reduce manufacturing cost of hardware by making the negative set-down waveform have the same voltage level as the voltage level of the scan waveform.

In the address period, the negative scan pulse is sequentially applied to the scan electrodes and, at the same time, a positive address pulse is applied to the address electrodes in synchronization with the scan pulse. When difference in voltage between the scan pulse and the address pulse is added to the wall voltage generated in the reset period, address discharge is generated in the discharge cell to which the address pulse is applied. Wall charges to the amount that can generate discharge when the negative sustain voltage −Vs is applied are formed in the cells selected by the address discharge.

Here, according to the first embodiment of the present invention, since a voltage of a negative region is used for the scan waveform applied to the scan electrodes of the address period as well as the sustain period is used, it is possible to effectively reduce power consumption. At this time, in the case of using the scan waveform for the negative region, when the scan voltage falls to the negative sustain voltage −Vs, though the address voltage Va is not applied to the address electrodes, mis-discharge is generated due to surface discharge between the scan electrodes and the sustain electrodes.

Therefore, the scan reference waveform of the voltage level no more than the ground GND voltage level and the negative scan waveform of the voltage level lower than the voltage level of the scan reference waveform and higher than the voltage level of the negative sustain waveform are applied to the scan electrodes according to the first embodiment of the present invention.

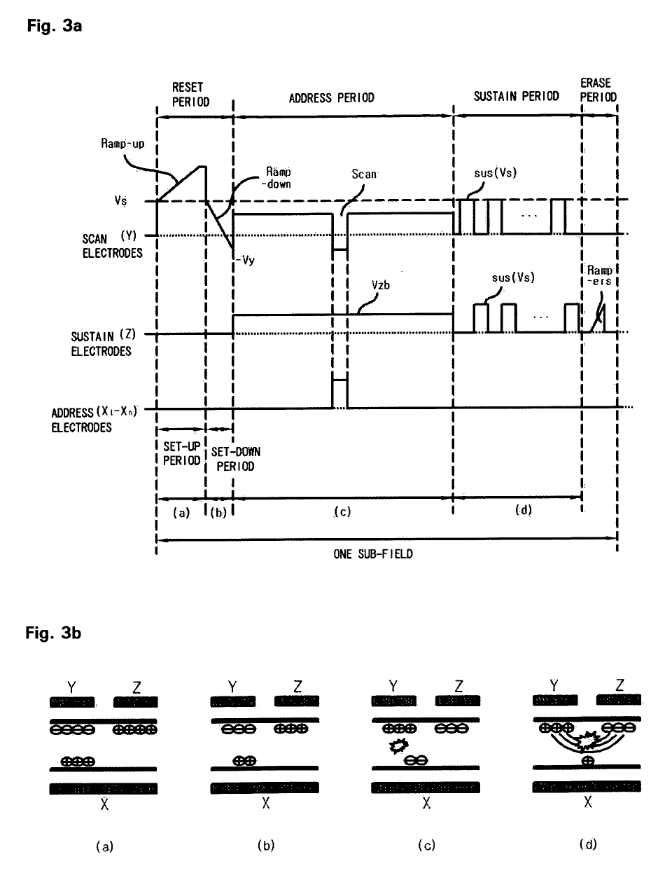

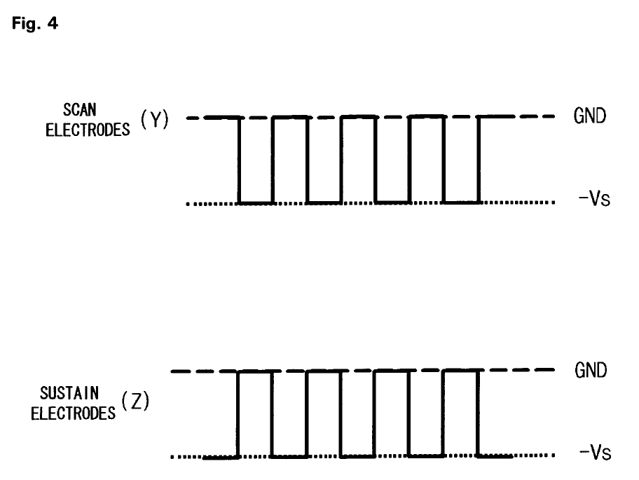

Also, the reference waveform of the ground GND voltage level is applied to the sustain electrodes according to the first embodiment of the present invention in the address period. Therefore, it is possible to reduce difference in voltage between the scan electrodes and the sustain electrodes to thus prevent mis-discharge from being generated between the scan electrodes and the sustain electrodes. Also, the reference waveform of the ground GND voltage level is applied to the sustain electrodes unlike in the conventional art where an additional positive bias voltage Vzb is supplied as illustrated in FIG. 3A so that it is possible to reduce manufacturing cost.

In the sustain period, the negative sustain waveform is alternately applied to the scan electrodes and the sustain electrodes. In the cells selected by the address discharge, the wall voltage in the cells is added to the sustain pulse such that the sustain discharge, that is, display discharge is generated between the scan electrodes and the sustain electrodes whenever each sustain pulse is applied. At this time, as described above, low voltage driving is performed due to the priming effect caused by the negative sustain waveform. The voltage level of the negative sustain waveform is preferably −160V to −200V.

In the erase period, a negative erase waveform is applied unlike in the conventional art where the positive erase waveform is applied. At this time, in accordance with the final wall charge state of the sustain period in the discharge cell, that is, in accordance with to which electrodes between the scan electrodes and the sustain electrodes the final negative sustain waveform is applied, the negative erase waveform is applied to the opposite electrodes of the electrodes to which the final negative sustain waveform is applied.

At this time, according to the first embodiment of the present invention, a rising ramp waveform that gradually rises from the voltage −Vs level of the negative sustain waveform to the ground GND voltage level is formed. While the erase waveform is applied, the negative waveform is applied to the electrodes to which the final sustain waveform is applied. Therefore, dark discharge is generated in the cells of the entire screen due to difference in voltage between the rising ramp waveform and the negative waveform so that the wall charges that reside are erased.

Also, in order to erase the wall charges of the entire screen, the time for which the negative erase waveform is applied is preferably no less than 2 us.

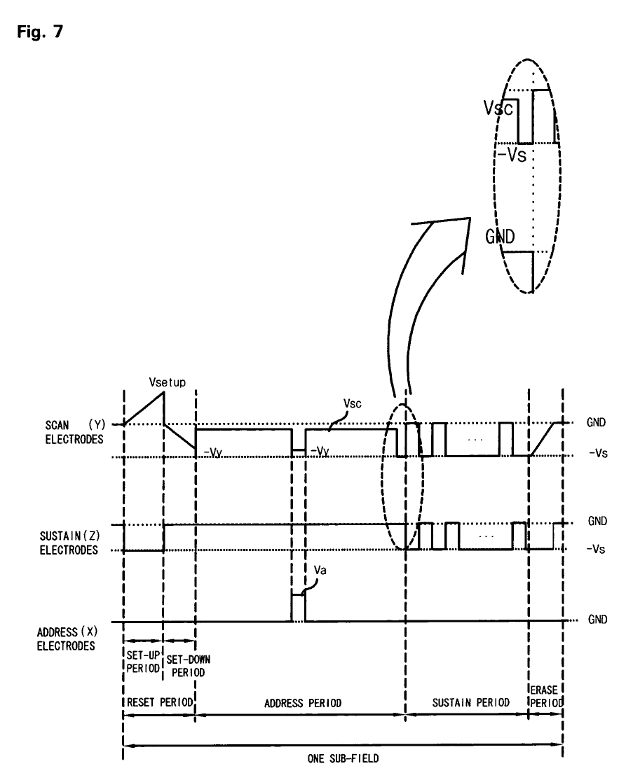

FIG. 7 illustrates modified driving waveforms according to the first embodiment of the present invention.

As illustrated in FIG. 7, in the modified driving waveforms according to the first embodiment of the present invention, each sub-field is divided into a reset period for initializing all of the cells, an address period for selecting a cell to be discharged, a sustain period for sustaining discharge of the selected cell, and an erase period for erasing the wall charges in the discharged cell.

Since the reset period, the address period, the sustain period, and the erase period of the modified driving waveforms according to the first embodiment of the present invention have the same characteristics as the reset period, the address period, the sustain period, and the erase period of the driving waveforms according to the first embodiment of the present invention described with reference to FIG. 6, description thereof will be omitted.

Here, in the modified driving waveforms according to the first embodiment of the present invention, after the address discharge of the address period in which the negative voltage level is used is completed, the ground GND voltage level is sustained in the sustain electrodes and the negative waveform is applied to the scan electrodes for a predetermined time. After the address discharge is completed, since positive wall charges are formed in the scan electrodes, the negative waveform is applied before applying the sustain pulse to reinforce the positive wall charges of the scan electrodes. Therefore, it is possible to stably perform sustain discharge.

At this time, the voltage level of the negative waveform is the same as the voltage −Vs level of the negative sustain waveform and the predetermined time is no less than 1 us in order to reinforce the wall charges enough.

### Second Embodiment

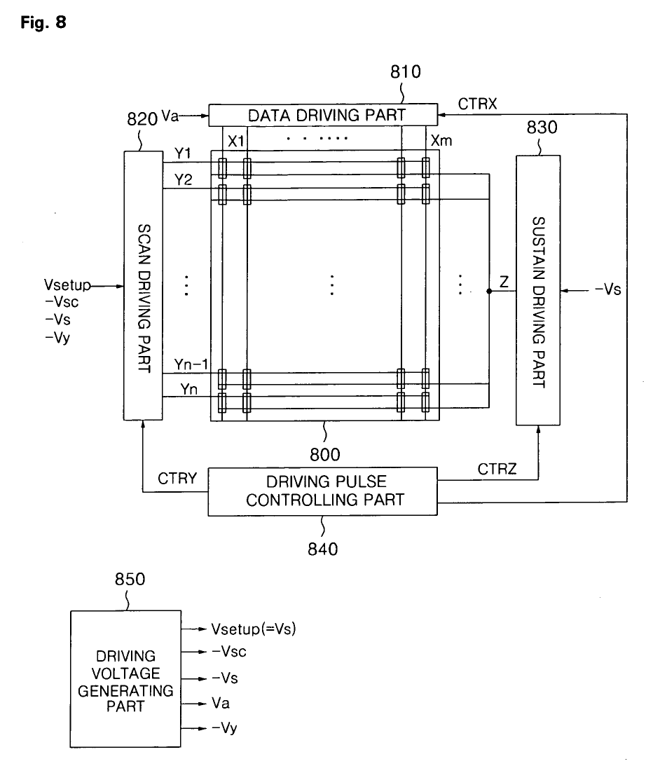

FIG. 8 illustrates the structure of a plasma display apparatus according to the second embodiment of the present invention.

As illustrated in FIG. 8, the plasma display apparatus according to the second embodiment of the present invention includes a plasma display panel (PDP) 800, a data driving part 810, a scan driving part 820, a sustain driving part 830, a driving pulse controlling part 840, and a driving voltage generating part 850.

Since the operations of the PDP 800, the data driving part 810, the driving pulse controlling part 840, and the driving voltage generating part 850 are the same as the respective parts of the plasma display apparatus according to the first embodiment of the present invention illustrated in FIG. 5, detailed description thereof will be omitted.

The scan driving part 820 according to the second embodiment of the present invention drives the scan electrodes Y1 to Yn formed in the PDP 800. First, in the reset period, the scan driving part 820 forms a ramp waveform under the control of the driving pulse controlling part 840 and supplies a set-up pulse that rises to a set-up voltage Vsetup level and a set-down pulse that falls to a set-down voltage −Vy to the scan electrodes Y1 to Yn.

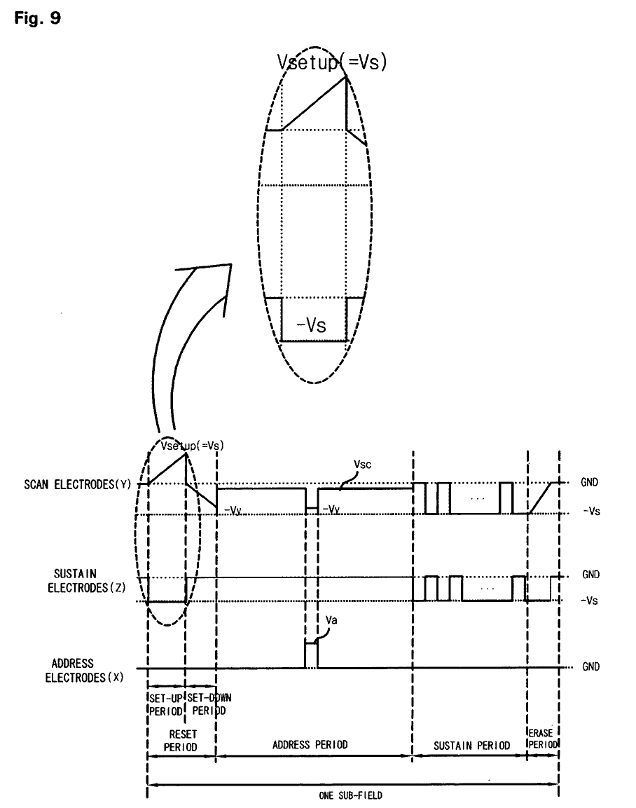

Here, the set-up pulse according to the second embodiment of the present invention forms a positive waveform. The voltage level of the positive set-up waveform having a voltage of the same size as the negative sustain voltage −Vs is much lower than the voltage level of the conventional set-up pulse. The negative waveform is applied to the sustain electrodes Z in order to have a low voltage level. Detailed description of the above will be described with reference to the driving waveforms of FIG. 9.

Then, in the address period, the scan pulse applied from the scan reference voltage −Vsc to the scan voltage −Vy is sequentially supplied to the scan electrodes Y1 to Yn. Here, the same voltage supplied by the driving voltage generating part 850, that is, −Vy is used for a set-down waveform and a scan waveform.

Then, the scan driving part 820 supplies one or more negative sustain pulses applied to the negative sustain voltage −Vs in the ground GND level for sustain discharge to the scan electrodes Y1 to Yn.

The sustain driving part 830 drives the sustain electrodes Z that form common electrodes in the PDP 800. The sustain driving part 830 supplies the negative pulse of the level the same as the level of the negative sustain voltage Vs to the sustain electrodes Z under the control of the driving pulse controlling part 840 in the set-up period. In the address period, the reference pulse of the ground GND voltage level is supplied to the sustain electrodes Z. In the sustain period, one or more negative sustain pulses applied to the negative sustain voltage −Vs in the ground GND voltage level for sustain discharge are supplied to the sustain electrodes Z.

As described above, the plasma display apparatus according to the second embodiment of the present invention applies the low driving voltage generated by the voltage driving part 850 under the control of the driving pulse controlling part 840 to the PDP 800 through the driving parts 810, 820, and 830.

In particular, according to the second embodiment of the present invention, a set-up pulse that forms the waveform of the low voltage unlike in the conventional art is applied in the set-up period according to the second embodiment. Here, the driving pulses formed by the plasma display apparatus according to the second embodiment will be described with reference to FIG. 9.

FIG. 9 illustrates the driving waveforms of the plasma display apparatus according to the second embodiment of the present invention.

As illustrated in FIG. 9, the plasma display apparatus according to the second embodiment of the present invention is driven so that each sub-field is divided into a reset period for initializing all of the cells, an address period for selecting a cell to be discharged, a sustain period for sustaining the discharge of the selected cell, and an erase period for erasing the wall charges in the discharged cell.

In the set-up period of the reset period, the rising ramp waveform Ramp-up is simultaneously applied to all of the scan electrodes. Due to the rising ramp waveform, weak dark discharge is generated in the discharge cells of the entire screen. Positive wall charges are accumulated on the address electrodes and the sustain electrodes and the negative wall charges are accumulated on the scan electrodes due to the set-up discharge.

At this time, according to the second embodiment of the present invention, in the set-up period, the positive set-up waveform is applied and the negative waveform is applied to the sustain electrodes. That is, the set-up waveform of the voltage level lower than the voltage level of the conventional set-up voltage is applied and the negative waveform that forms inverse polarity is applied to the sustain electrodes in order to have difference in voltage equal to the difference in voltage of the conventional art.

The positive set-up waveform preferably forms a rising ramp waveform that gradually increases in the ground GND voltage level. The magnitude of voltages of the positive set-up waveform and the negative waveform is equal to the magnitude of the voltage Vs of the negative sustain waveform. Therefore, according to the second embodiment of the present invention, a low voltage waveform is applied in the set-up period so that it is possible to improve driving efficiency and to stably drive the plasma display apparatus.

According to the second embodiment of the present invention, in the set-down period, the negative set-down waveform having the voltage −Vy level the same as the voltage level of the scan waveform is applied to the scan electrodes. It is possible to reduce manufacturing cost of hardware by making the negative set-down waveform have the same voltage level as the voltage level of the scan waveform.

Also, according to the second embodiment of the present invention, in the address period, a voltage of a negative region is used. Therefore, it is possible to effectively reduce power consumption.

Also, according to the second embodiment of the present invention, in the sustain period, the negative sustain waveform is alternately applied to the scan electrodes and the sustain electrodes. The voltage level of the negative sustain waveform is preferably −160V to −200V.

Also, according to the second embodiment of the present invention, the negative erase waveform is applied unlike in the conventional art where the positive erase waveform is applied. At this time, in order to erase the wall charges of the entire screen enough, the time for which the negative erase waveform is applied is preferably no less than 2 us.

As described above, according to the embodiments of the present invention, the driving voltage of the plasma display apparatus is reduced in the entire periods as well as in the sustain period so that it is possible to improve driving efficiency, to reduce manufacturing cost, and to stably drive the plasma display apparatus.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display apparatus comprising:
a plasma display panel in which a plurality of electrodes including scan electrodes and sustain electrodes are formed;
driving parts for driving the plurality of electrodes; and
a driving pulse controlling part for controlling the driving parts so that a scan reference waveform of a voltage level no more than a ground voltage level and a negative scan waveform of a voltage level lower than the voltage level of the scan reference waveform and higher than the voltage level of the negative sustain waveform are applied to the scan electrodes in an address period and that a negative sustain waveform is alternately applied to the scan electrodes and the sustain electrodes in a sustain period.

2. The plasma display apparatus as claimed in claim 1, wherein a reference waveform of the ground voltage level is applied to the sustain electrodes in the address period.

3. The plasma display apparatus as claimed in claim 2, wherein, after address discharge of the address period is completed, the sustain electrodes are sustained in the ground voltage level and a negative waveform is applied to the scan electrodes for a predetermined time.

4. The plasma display apparatus as claimed in claim 3, wherein the predetermined time is no less than 1 us.

5. The plasma display apparatus as claimed in claim 3, wherein the voltage level of the negative waveform is the same as the voltage level of the negative sustain waveform.

6. A plasma display apparatus comprising:
a plasma display panel in which a plurality of electrodes including the scan electrodes and the sustain electrodes are formed;
driving parts for driving the plurality of electrodes; and
a driving pulse controlling part for controlling the driving part so that a positive set-up waveform is applied to the scan electrodes and that a negative waveform is applied to the sustain electrodes in a set-up period and that a negative sustain waveform is alternately applied to the scan electrodes and the sustain electrodes in a sustain period.

7. The plasma display apparatus as claimed in claim 6, wherein the positive set-up waveform is a rising ramp waveform that gradually rises in a ground GND voltage level.

8. The plasma display apparatus as claimed in claim 6, wherein the magnitude of the voltages of the positive set-up waveform and the negative waveform is equal to the magnitude of the voltage of the negative sustain waveform.

9. The plasma display apparatus as claimed in claim 1 or 6, wherein the voltage level of the negative sustain waveform is −160V to −200V.

10. The plasma display apparatus as claimed in claim 1 or 6, wherein a negative set-down waveform having the voltage level the same as the voltage level of a scan waveform is applied to the scan electrodes in a set-down period.

11. The plasma display apparatus as claimed in claim 1 or 6, wherein, after the final negative sustain waveform of the sustain period is applied to one of the scan electrodes and the sustain electrodes, a negative erase waveform is applied to the opposite electrodes of one of the scan electrodes and the sustain electrodes to which the final negative sustain waveform is applied.

12. The plasma display apparatus as claimed in claim 11, wherein the negative erase waveform is a rising ramp waveform that gradually rises from the voltage level of the negative sustain waveform to the ground voltage level.

13. The plasma display apparatus as claimed in claim 11, wherein the time during which the negative erase waveform is applied is no less than 2 us.

14. The plasma display apparatus as claimed in claim 11, wherein a negative waveform is applied to the electrodes to which the final sustain waveform is applied, while a negative erase waveform is applied to the opposite electrodes.

15. A method of driving a plasma display apparatus in which a negative sustain waveform is alternately applied to the scan electrodes and the sustain electrodes in a sustain period, wherein a scan reference waveform of the voltage level no more than a ground voltage level and a negative scan waveform of the voltage level lower than the voltage level of the scan reference waveform and higher than the voltage level of the negative sustain waveform are applied to the scan electrodes in an address period.

16. The method as claimed in claim 15, wherein a reference waveform of a ground voltage level is applied to the sustain electrodes in the address period.

17. The method as claimed in claim 16, wherein, after address discharge of the address period is completed, a ground voltage level is sustained in the sustain electrodes and a negative waveform is applied to the scan electrodes for a predetermined time.

18. The method as claimed in claim 17, wherein the predetermined time is no less than 1 us.

19. The method as claimed in claim 17, wherein the voltage level of the negative waveform is the same as the voltage level of a negative sustain waveform.

20. A method of driving a plasma display apparatus in which a negative sustain waveform is alternately applied to scan electrodes and sustain electrodes, wherein a positive set-up waveform is applied to the scan electrodes and a negative waveform is applied to the sustain electrodes in a set-up period.

21. The method as claimed in claim 20, wherein the positive set-up waveform is a rising ramp waveform that gradually rises from a ground voltage level.

22. The method as claimed in claim 20, wherein the magnitude of the voltages of the positive set-up waveform and the negative waveform is equal to the magnitude of the voltage of a negative sustain waveform.

23. The method as claimed in any one of claims 15 to 20, wherein the voltage level of the negative sustain waveform is −160V to −200V.

24. The method as claimed in any one of claims 15 to 20, a negative set-down waveform having the same voltage level as the voltage level of a scan waveform is applied to the scan electrodes in a set-down period.

25. The method as claimed in any one of claims 15 to 20, wherein, after the final negative sustain waveform of the sustain period is applied to one of the scan electrodes and the sustain electrodes, a negative erase waveform is applied to the opposite electrodes of the electrodes to which the negative sustain waveform is applied.

26. The method as claimed in claim 25, wherein the negative erase waveform is a rising ramp waveform that gradually rises from the voltage level of the negative sustain waveform to the ground voltage level.

27. The method as claimed in claim 25, wherein the time for which the negative erase waveform is applied is no less than 2 us.

28. The method as claimed in claim 25, wherein, while a negative erase waveform is applied to the opposite electrodes, a negative waveform is applied to the electrodes to which the final sustain waveform is applied.
